(19) United States
(12) Patent Application Publication
(10) Pub. No.: US 2025/0189988 A1
(43) Pub. Date: Jun. 12, 2025

(54) Robust Control Strategy For Autonomous Robot Mobility With Offboard Positioning System

(71) Applicant: The Regents of The University of Michigan, Ann Arbor, MI (US)

(72) Inventors: Bogdan EPUREANU, Ann Arbor, MI (US); Koji SHIONO, Ann Arbor, MI (US)

(73) Assignee: The Regents of The University of Michigan, Ann Arbor, MI (US)

(21) Appl. No.: 18/971,367

(22) Filed: Dec. 6, 2024

Related U.S. Application Data
(60) Provisional application No. 63/607,681, filed on Dec. 8, 2023.

(51) Int. Cl. G05D 1/69

(52) U.S. Cl. CPC G05D 1/69

(57) ABSTRACT

A robot control system is presented for a monitored environment. The control system includes: a central computer; and a plurality of sensors in data communication with the central computer. Each sensor is at a fixed location in the monitored environment and is configured to detect location of objects in the monitored environment. A plurality of robots also resides in the monitored environment. Each robot is comprised of a wireless communication receiver, a regulator, an actuator and a power source, such that the regulator receives motion commands directly from the central computer via the wireless communication receiver. It is noted that the robots are not configured with sensors to help navigate the robot.

### CROSS-REFERENCE TO RELATED APPLICATIONS

This application claims the benefit of U.S. Provisional Application No. 63/607,681, filed on Dec. 8, 2023. The entire disclosure of the above application is incorporated herein by reference.

### FIELD

The present disclosure relates to a robust control strategy for autonomous robot mobility with offboard positioning system.

### BACKGROUND

Autonomous robots have become more prevalent especially in manufacturing environments. Conventional approaches employ robots with onboard sensors such that input from the sensors is used for path planning and execution, which determine and execute path planning. This approach typically requires large amounts of onboard computing resources and has high power consumption. There is a need to develop a robust robot control system that addresses these deficiencies.

This section provides background information related to the present disclosure which is not necessarily prior art.

### SUMMARY

This section provides a general summary of the disclosure, and is not a comprehensive disclosure of its full scope or all of its features.

In one aspect, a robot control system is presented for a monitored environment. The robot control system comprises: a central computer; a plurality of sensors in data communication with the central computer; and a plurality of robots residing in the monitored environment. Each sensor is at a fixed location in the monitored environment and is configured to detect location of objects in the monitored environment. Each robot is comprised of a wireless communication receiver, a regulator, an actuator and a power source, such that the regulator receives motion commands directly from the central computer via the wireless communication receiver. Each robot is also without sensors configured to navigate the robot.

The central computer is configured to receive location data for the plurality of robots from the plurality of sensors and determine a path for each robot in the plurality of robots. The central computer also runs a computer process for each robot in the plurality of robots, such that the computer process determines a trajectory for a given robot and issues the motion command to the given robot in accordance with the trajectory. In some embodiments, the central computer implements a traffic controller, where the traffic controller detects intersections amongst the paths determined for each robot in the plurality of robots and notifies computer processes for applicable robots of the intersections.

In some implementations, the monitored environment is partitioned into two or more regions and the central computer implements a region handler for each of the two or more regions.

In another aspect, a computer-implemented method is presented to control a plurality of robots in a monitored environment. The method includes: constructing a costmap for the monitored environment, where each cell in the cost map contains a numeric value indicating how undesirable it is to traverse in vicinity of that specific cell; for each robot in the plurality of robots, sharing the costmap to the robot; for each robot in the plurality of robots, determining a path for the robot to move in the monitored environment; and updating numeric values in the costmap assigned to the given robot at periodic time intervals in accordance with paths determined for the remainder of robots in the plurality of robots. The method may further include controlling movement of the given robot in accordance with the updated costmap assigned to the given robot.

Constructing the costmap includes assigning numeric values to each cell in the costmap for obstacles in the monitored environment. In some embodiments, the costmap for the monitored environment is constructed at the period time intervals, where the obstacles in the monitored environment include stationary objects and moving objects.

For each robot in the plurality of robots, determining a path for the robot to move in the monitored environment includes sharing the path for the robot with the remainder of robots in the plurality of robots. Furthermore, updating numeric values in the costmap assigned to the given robot includes, for each of the remainder of robots in the plurality of robots, determining an individual robot cost for each cell in relation to the path of the given robot, such that the individual robot cost accounts for the path of the given robot and the path of the other robot. More specifically, updating numeric values in the costmap assigned to the given robot further includes, for each cell in the costmap, summing the corresponding individual robot costs for each of the remainder of robots and adding sum of individual robot costs to numeric value of corresponding cell in the costmap.

In yet another aspect, a computer-implemented method is presented for determining an unobstructed height underneath an object in a monitored environment. The method includes: measuring, by a first sensor, a first distance from a location on the ground surface directly below the first sensor to an incident location on a ground surface underneath an object, where a hypotenuse of a right triangle intersects with an outer underside edge of the object and the right triangle is formed by the first sensor, the incident location and the location on the ground surface directly below the first sensor; measuring, by a second sensor, a second distance from a location on the ground surface directly below the second sensor to a second incident location on a ground surface underneath the object, where a hypotenuse of a second right triangle intersects with the outer underside edge of the object and the second right triangle is formed by the second sensor, the second incident location and the location on the ground surface directly below the second sensor; and computing, by a computer processor, an unobstructed height underneath the object using the first distance and the second distance, where height of the first sensor above the ground surface, the height of the second sensor above the ground surface, and a distance between the first sensor and the second sensor is known.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of a monitored environment.

FIG. 2 is a block diagram of an example hardware architecture for a robot control system.

FIG. 3 is a block diagram of an example software architecture for a robot control system.

FIGS. 4A and 4B are diagrams depicting a handover process when a robot moves between regions in the monitored environment.

FIG. 5 is a flowchart depicting a technique for controlling robots in a given region using costmaps.

FIG. 6 is a diagram illustrating relationship of right triangles used to calculate the unobstructed height underneath on object.

Corresponding reference numerals indicate corresponding parts throughout the several views of the drawings.

### DETAILED DESCRIPTION

Example embodiments will now be described more fully with reference to the accompanying drawings.

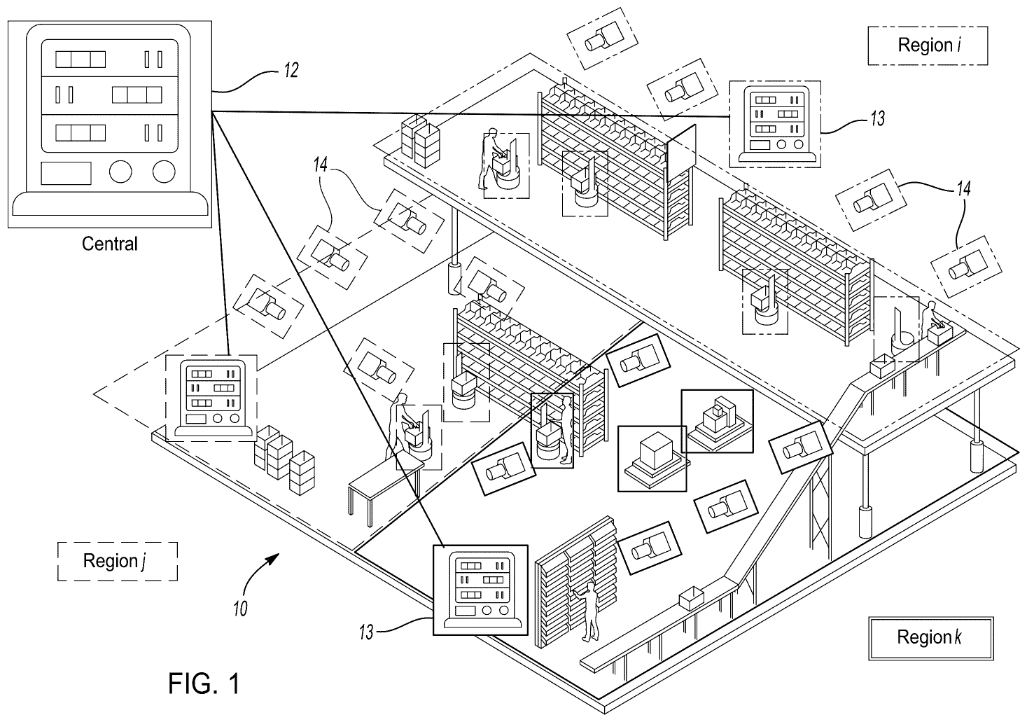

FIG. 1 depicts an example of a monitored environment. A robot control system 10 monitors and controls robots moving throughout the monitored environment. In this example, the environment is partitioned into three different regions: Region i, Region j and Region k. Depending on the application, it is understood that the environment may be partitioned into more or fewer regions.

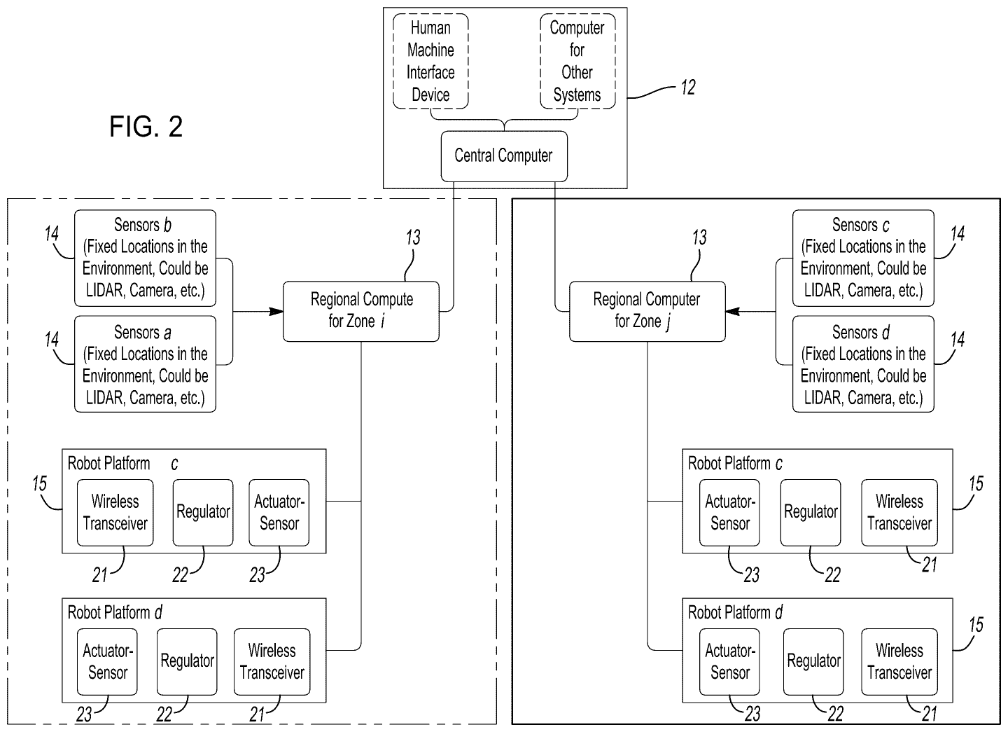

With reference to FIGS. 1 and 2, the robot control system 10 is comprised of a central computer 12 and a plurality of sensors 14 in data communication with the central computer 12. In one implementation, the central computer 12 is in data communication with two or more regional computers 13, where each region has an associated regional computer. Each regional computer 13 is in turn in data communication with one or more sensors 14. In other implementations, the central computer may be interfaced directly with the sensors without the intermediary regional computers. It is readily understood that the central computer 12, the regional computers 13 and the sensors 14 may be interconnected by wired connections, wireless connections or combination thereof.

A plurality of robots 15 also reside in the monitored environment. Each robot 15 is comprised of a wireless communication receiver 21, a regulator 22, an actuator 23 and a power source 24. During operation, a robot receives a motion command directly from the central computer 12 via the wireless communication receiver 21. The motion command is in turn input to the regulator 22 which passes the motion command on to an actuator. For example, actuator may be a motor coupled to a rotary shaft that drives the wheels of the robot. In this example, the regulator 22 translates the motion command to a magnitude of current which is supplied to the motor. In most instances, a sensor (e.g., a current sensor) is used to monitor the motion of the actuator 23 and provide feedback to the regulator. The regulator 22 in turn acts to compare a measure signal to a desired signal and adjust its output accordingly. In some embodiments, the robots 15 may be configured with microphones to monitor audio communication from nearby human operators. Instructions and information received from the human operators can be transmitted to the central computer 12 and used for path planning. It is noted that each robot 15 is without sensors configured to navigate the robot.

In the example embodiment, the central computer 12 is configured to receive location data for the plurality of robots 15 from the plurality of sensors 14 and determine a path for each robot in the monitored environment. A path is a sequence of points defined by their coordinates. To do so, the central computer 12 sends the path information for each robot to the corresponding regional computer 13 that executes a computer process for each robot, such that the computer process determines a trajectory for a given robot and issues the motion commands to the given robot in accordance with the trajectory. In some embodiments, the central computer 12 includes a human interface configured to receive a gesture from an operator and in turn translate the gesture into a motion commend for a given robot. For example, the central computer 12 may include a microphone configured to receive a voice command from an operator and translate the voice command into a motion command for the given robot. Other types of human interfaces are also contemplated by this disclosure.

Within each region, one or more sensors 14 are placed at fixed locations in the region and configured to detect location of objects in the monitored environment. In an example embodiment, the sensors are cameras. One can envision the use of other types of sensors including but not limited to LIDAR sensors.

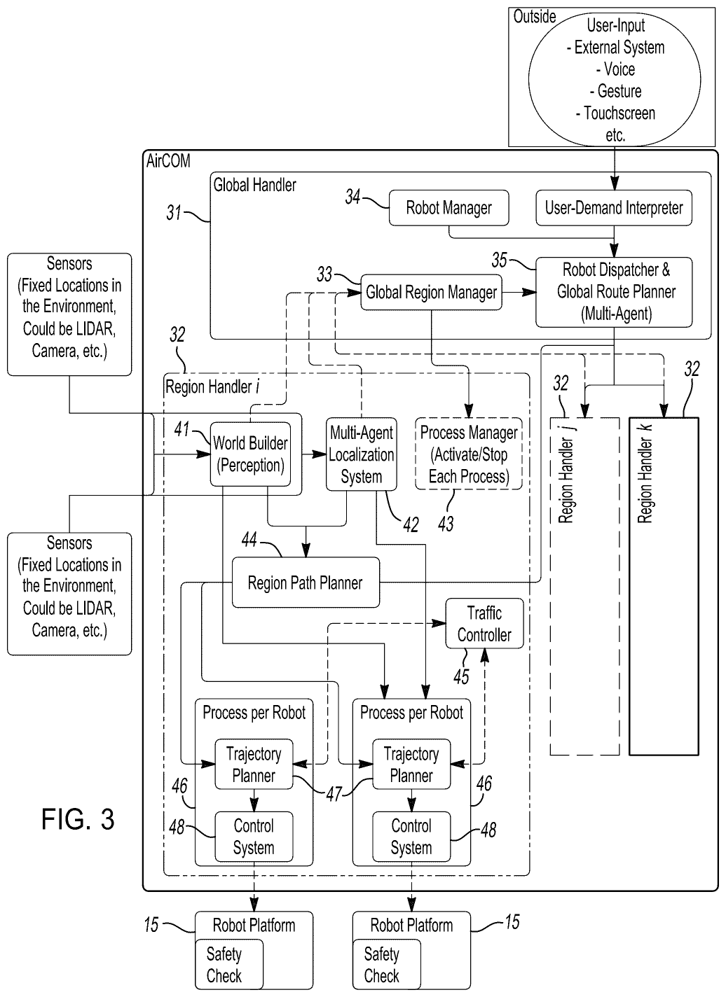

FIG. 3 depicts an example implementation of a software architecture for the robot control system 10. The software architecture is comprised generally of a global handler 31 and a region handler 32 for each region of the monitored environment. In this example, there is a region handler 32 for Region i, Region j and Region k. In the case of a single region, there would be only a single region handler. The global handler 31 is executed on the central computer 12; whereas, the region handlers are executed on corresponding regional computers 13

The global handler 31 includes a global region manager 33, a robot manager 34 and a robot dispatcher and global path planner 35. The robot manager 34 maintains a list of robots available for use in the monitored environment. Each entry in the list of robots includes information about the robot, including but not limited to an operational status, a battery status, etc. The robot dispatcher and global path planner 35 receives a list of robot tasks and allocates the tasks to particular robots. Each robot task includes an origination location and a destination location. For example, a location to pick-up an object and a location to deliver the object. The robot dispatcher and global path planner then charts a coarse path for the robot assigned to the task based on its current location. Robots may be assigned to tasks using different selection methods such as a robot whose current location is closest to the origination location of the task is assigned to that task.

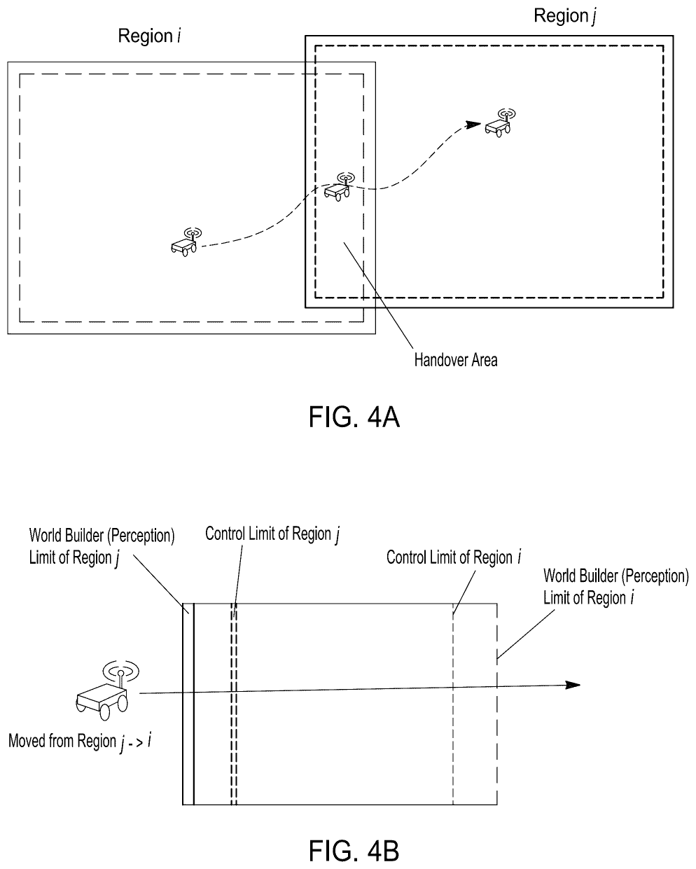

The global region manager 33 is responsible for coordinating movement of the robots between regions. To coordinate movement of robots between regions, a handover (or overlap) region is defined between the two regions as seen in FIGS. 4A and 4B. As a robot moves from Region i to Region j, a handoff process is followed. When the robot crosses the perception limit of Region j, the controller for the robot in Region j is started. While the robot remains inside the control limit of Region I, the robot is controlled by the controller of Region i. Additionally, the controller of Region j continues to calculate and check the validity of its solution against the solution computed by the controller of Region i. Once the robot crosses the control limit of Region i, the controller of Region i no longer sends motion commands to the robot and the controller of Region j begins issuing motion commands to the robot.

With continued reference to FIG. 3, a region handler 32 includes a world builder 41, a multi-agent localization system 42, a process manager 43, a regional path planner 44, a traffic controller 45 and a process 46 for each robot residing in a given region. The world builder 41 receives input from the sensors 38 arranged to monitor the given region and constructs an occupancy map. The occupancy map describes at each given moment in time all the areas of space occupied by obstacle objects found in the given region. The multi-agent localization system 42 also receives input from the sensors 38 arranged in the given region. The multi-agent localization system 42 determines and updates positions for each of the robots in the given region.

Each process 46 runs in parallel and independently from the other computer processes 46 run by the region handler 32. The process manager 43 manages the starting and stopping of the computer processes for the robots in the region. For example, as a particular robot moves into or out of a region, the process manger 43 can start and stop of computer process for the particular robot.

The regional path planner 44 is configured to receive the occupancy map of the given region from the world builder 41, the position data for each robot in the given region from the localization system 42, and the desired destination for each robot in a given region from the robot dispatcher and global path planner 35. The regional path planner 44 in turn calculates a path for each of the robots in the given region. The path defines a route from a robot's current location to the desired destination. For further details regarding exemplary path planning methods, reference may be had to LaValle, S. M., “Planning Algorithms,” Cambridge University Press, 2006; or Dolgov, D., Thrun, S., Montemerlo, M. and Diebel, J., “Practical search techniques in path planning for autonomous driving” Ann Arbor, 1001 (48105), pp. 18-80, 2008, which are incorporated herein by reference.

During operation, a computer process 46 for each robot is run by the region handler 32. The computer process 46 determines a trajectory for a given robot and issues motion commands to the given robot in accordance with the trajectory, where the trajectory defines the movement of the robot in the near term (e.g., next five seconds). In an example embodiment, the trajectory for a given robot is determined using a costmap as is further described below and the motion commands are issued by a local controller. For further details regarding exemplary path planning methods, reference may be had to any one of the following: Mayne, D. Q., “Model Predictive Control: Recent Developments and Future Promise,” Automatica, Vol. 50, No. 12, 2014, pp. 2967-2986; Hewing, L., Wabersich, K. P., Menner, M., and Zeilinger, M. N., “Learning-Based Model Predictive Control: Toward Safe Learning in Control,” Annual Review of Control, Robotics, and Autonomous Systems, Vol. 3, No. 1, 2020, pp. 269-296; Sutton, R. S., and Barto, A. G., “Reinforcement Learning: An Introduction,” Bradford Books, Cambridge, MA, 2018; Williams, G., Drews, P., Goldfain, B., Rehg, J. M., and Theodorou, E. A., “Information-Theoretic Model Predictive Control: Theory and Applications to Autonomous Driving,” IEEE Transactions on Robotics, Vol. 34, No. 6, 2017, pp. 1603-1622.

Each process 46 is also interfaced with the traffic controller 45 for the region. The traffic controller 45 detects intersections amongst the paths determined for the robots in the given region and notifies the computer processes 46 for applicable robots of the intersections. To do so, the traffic controller 45 receives a list of priorities for all robots from robot dispatcher 34. The traffic controller 45 also receives the planned paths and the speed along the path from a trajectory planner of the computer processes 46. The traffic controller 45 calculates anticipated collisions, where a collision may be defined as an occurrence of a small distances between two or more robots measured in the 3D space of x coordinate, y coordinate, and time. For each anticipated collision detected and for each robot involved in the anticipated collision, the traffic controller 45 may iteratively lower the speed of one robot at a time, starting from the highest priority robot to the lowest priority robot. For each anticipated collision detected, the reduction in speed of the highest priority robot is zero. The process of lowering speed concludes when no collisions are anticipated over the next time horizon. Once no collisions are anticipated, the modified speeds are communicated by the traffic controller 45 to the parallel computer processes 46 that execute the individual robot planning and control. In other implementations, the traffic controller 45 may modify the path of a robot to avoid collisions. The traffic controller 45 is centralized while at the same time operating with decentralized planned robot paths. The traffic controller 45 is also very simple compared to other existing methods because it does not require any path changes for any robot. Rather, it uses only speed control. The traffic controller 45 does not solve all potential collision scenarios. Existing methods can solve more complex collision scenarios, but they are slower, or they require each robot to change their path, or they require centralized path planning.

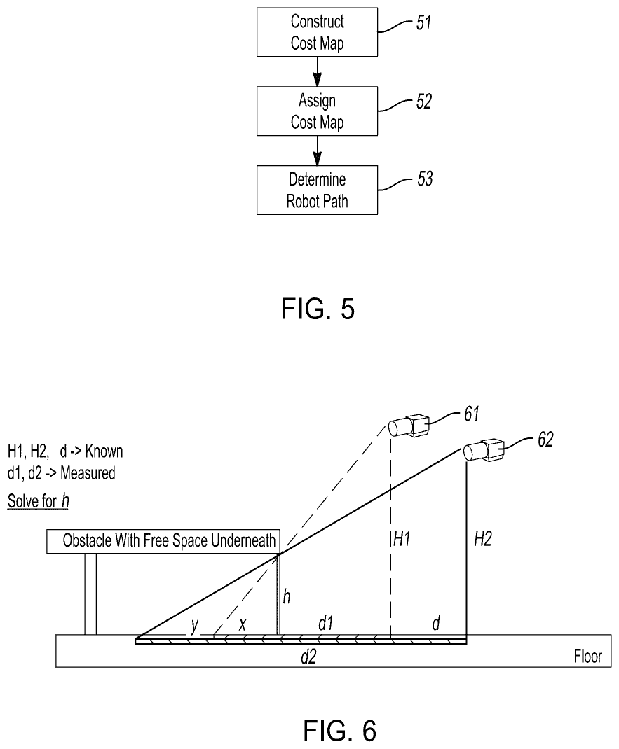

FIG. 5 further depicts a technique for controlling robots in a given region using costmaps. A costmap is a two-dimensional map representing a region of the monitored environment, where each cell (or point) in the costmap has a numeric value (i.e., cost) that signifies how difficult or undesirable it is to traverse that cell. High costs indicate an obstacle or undesirable area, while low costs indicate unobstructed navigable areas.

An independent path planner operates for each robot simultaneously. A costmap is constructed at 51 by the trajectory planner 46 of a process of computer 13. In the example embodiment, the costmap is comprised of two parts. The first part of the costmap is shared by all of the robots in a given region and is referred to herein as the shared costmap. It encodes occupancy map information about obstacles in the region as provided by the world builder 41. The second part of the costmap is customized for each robot in the region and is referred to herein as the individual costmap. This second part of the costmap encodes information about the most recent planned path and current locations of the other robots in the region. The costmap for a robot is the sum of the shared costmap and the individual costmap corresponding to that robot. Costs are higher near other robots and along their planned trajectories, with the cost decaying with the distance along the path of the other robots. This helps robots avoid interfering with each other's movements. The planned paths of other robots are provided by all other path planners within a region, and the current locations of other robots are provided by the multi-agent localization system within each region.

For each ego robot in a region, a costmap is constructed by the trajectory planner 46 and assigned to the ego robot as indicated at 52. The costmap of the ego robot is calculated as the sum of the shared costmap and the individual costmap for the ego robot. The individual costmap for the ego robot is based on the most recent known paths planned for all other robots. A path is then determined at 53 for each robot to move in the monitored environment. The planned paths are updated at each time step with the most recent known shared costmap and individual costmaps. In this way, path planners use the individual costmaps to compute paths that minimize cost independently for each robot, thus inherently avoiding obstacles and other robots while navigating to the defined goal by the robot dispatcher 35.

Robots are assigned priorities by the robot dispatcher system. Lower-priority robots have higher costs in the individual costmaps associated with the potential trajectories of other robots, encouraging them to yield to higher-priority robots. The customized costmap of each robot is modified based on the priorities within each region. All path planning processes run in parallel, enabling the system to scale and handle multiple robots efficiently. Coordination is achieved through the costmap of each robot, which encode information about other robots' intentions (plans).

In the example embodiment, the costmap combines elements of both centralized and decentralized robot operation systems. The shared costmap based on obstacles derived from the occupancy map provides centralized information, while the individual costmap allows for decentralized path planning and collision avoidance. This hybrid approach offers the benefits of both paradigms-centralized knowledge and decentralized adaptability. Additionally, the costmap method is relatively simple compared to other approaches for fusing all other planned paths. It does not require complex negotiations or path replanning. Each robot simply optimizes its own path based on its costmap, leading to inherent coordination. This simplicity makes the system scalable to large numbers of robots.

Furthermore, the costmap's built-in collision avoidance mechanism, through the cost associated with other robots' paths, simplifies the process compared to other methods that may require complex negotiations or frequent re-planning. The costmap's ability to incorporate real-time information about other robots' intentions and the environment enables more reactive and adaptive navigation than traditional methods that may rely on static information. The costmap approach minimizes communication overhead, as robots coordinate through the shared information encoded in their costmaps. This contrasts with some multi-robot systems that rely on extensive communication, which can be a bottleneck in practice. Lastly, the costmap's ability to assign priorities and incorporate robot-specific information allows for better handling of heterogeneous robot teams with varying capabilities, which is a significant advantage over methods assuming homogeneous robots.

Within the software architecture described above, controlling an ego robot with a costmap is further described. The world builder 41 constructs an occupancy map and communicates it to the regional path planner 44 and to the trajectory planner 47. The regional path planner 44 calculates a preliminary path for each robot and transmits the preliminary path of the ego robot to the trajectory planner 47 of the ego robot. The robot paths planned in the most recent past by the trajectory planner 47 corresponding to each robot are communicated to the trajectory planner 47 of the ego robot at the current time. The robot locations determined by the multi-agent localization system 42 are also communicated to the trajectory planner 47 of the ego robot. In addition, the robot priorities established by the robot dispatcher and global path planner 35 are communicated to the trajectory planner 47 of the ego robot.

The trajectory planner 47 of the ego robot in turn calculates a shared costmap by using the occupancy map received from the world builder 41. The calculation of the shared costmap uses parameters that can be set a priori and can be optimized offline or online based on analysis of the robot movements during their operations over longer periods of time. The analysis considers risk factors such as the nearest distance of the planned path to obstacles or the number of events detected and addressed by the traffic controller 45 for the planned path. The trajectory planner 47 of the ego robot also calculates the individual costmap for the ego robot by using the robot paths, the robot locations and the robot priorities. The direction of the robot motion along its path is accounted for in the calculation of the costmap. For example, the points along the path closest to the current robot location have higher costs than points along the path that are farther away. Also, the left and right sides of the path can be set to have different costs. The calculation of the individual costmap uses parameters that can be set a priori and can be optimized offline or online based on analysis of the robot movements during their operations over longer periods of time. The analysis considers risk factors such as the nearest distance of the planned path to other robots or the number of events detected and addressed by the traffic controller 45 for the planned path. The trajectory planner 47 of the ego robot calculates a composite costmap for the ego robot by summing the shared costmap and the individual costmap.

Next, the trajectory planner 47 of the ego robot calculates the trajectory composed of path and speed along the path for the ego robot using the composite costmap of the ego robot. The trajectory planned by the trajectory planner 47 is transmitted to the traffic controller 45. The traffic controller 45 detects any collisions of robots with one another, and establishes modifications to the planned trajectories by changing the robot speed without altering the robot paths. The changed robot speeds are communicated to the trajectory planner 47. Finally, the control system component 48 of the robot's process 46 controls the robot motion to execute the trajectory planned by the trajectory planner and verified by the traffic controller 45.

An example implementation for calculating a composite costmap for an ego robot i is set forth below. The composite cost map is a set of values of cost for robot i defined at each moment in time t at all locations in the floor space

(x,y),ci(x,y,t)=s(x,y,t)+Σ_{j=1,j≠i}ⁿ(dᵢ(x,y,t),

where n is the number of robots in the robot system and other moving or stationary objects that the robot control system can control. s(x,y,t) is the cost assigned to objects in the occupancy map (i.e., the shared costmap). In a simple embodiment, the objects are stationary. In more robust embodiments, some objects are stationary but some may also be moving objects that are not controlled by the robot control system. For example, moving objects detected by the camera system at time t are labeled as obstacles at time t. Thus, s(x,y,t) is the same value for all our robots in the robot control system. The trajectory planner 47 for robot i plans a trajectory that minimize the cost cᵢ(x,y,t), which includes the cost s(x,y,t). Thus, applying a high value of s(x,y,t) at locations where an obstacle (static or dynamic) is present allows the planner to avoid colliding with static and dynamic obstacles that are not controllable by the robot control system.

The presence and intent of the other robots in the robot control system is encoded in dᵢ(x,y,t). dᵢ(x,y,t) is the cost assigned to robot i to avoid collisions of robot i with all other robots in the robot system and other moving or stationary objects that the robot control system can control. In particular, dᵢ(x,y,t) is also used to plan the trajectory of robot i to avoid traffic jams with other robots j in the robot system or other moving or stationary objects that the robot control system can control (with j≠i). dᵢ(x,y,t) is calculated at each moment in time based on the paths planned in the most recent past (time t−Δt, where Δt is a time duration, for example Δt=1 second) for all other robots in the robot system and other moving or stationary objects that the robot control system can control. Thus, dᵢ(x,y,t) is a function that is different for each robot (hence the subscript i). dᵢ(x,y,t) is constructed so that it has positive values along the path of all robots j in the robot system and other moving or stationary objects that the robot control system can control (with j≠i). Specifically, dᵢ(x,y,t)=Σ_{j=1, j≠i}ⁿd_{i,j}(x,y,t), where d_{i,j}(x,y,t) is the cost applied for robot i along the path of robot j. Namely d_{i,j}(x,y,t) is large when the location of coordinates (x,y) is close to the path of robot j at time t, and d_{i,j}(x,y,t) is large when the location of coordinates (x,y) is close to the location of robot j in the robot system or other moving or stationary object that the robot control system can control at time t.

In sum, s(x,y,t) contains both static and some of the dynamic obstacles (namely, those obstacles that are not controllable by the robot control system) and can be computed based on the occupancy map created by the world builder 41. dᵢ (x,y,t) is calculated for each robot i separately based on the most recently known paths planned by all robots j≠i. Δt each moment in time, robot i plans its path using the cost cᵢ(x,y,t). Thus, different robots do not use the same cost to plan their paths. The cost is specialized for each robot, namely cᵢ(x,y,t) is not the same value for all robots. dᵢ(x,y,t) encodes information regarding certain dynamic objects, namely the robots in the robot system and other moving or stationary objects that the robot control system can control.

In another aspect of this disclosure, a method is introduced for determining an unobstructed height underneath an object in the monitored environment. With reference to FIG. 6, this method is useful when robots need to move underneath objects, such as tables, shelving and other larger objects whose contact area with the ground is smaller than the area of their projection on the ground plane. This method relies on the object being in the field of view of at least two sensors.

A first distance (d1) is measured by a first sensor 61, where the first distance is a side of a first right triangle and the first right triangle is formed by the first sensor, an incident location on a ground surface underneath the object and the location on the ground surface directly below the first sensor. That is, the first distance is a distance between a location on the ground surface directly below the first sensor and the incident location on a ground surface underneath an object. It is noted that the hypotenuse of the first right triangle intersects with an outer underside edge of the object and the distance (H1) between the first sensor and the location on the ground surface directly below the first sensor is known.

Similarly, a second distance (d2) is measured by a second sensor 62, where the second distance is a side of a second right triangle and the second right triangle is formed by the second sensor, an incident location on a ground surface underneath the object and the location on the ground surface directly below the second sensor. That is, the second distance is a distance between a location on the ground surface directly below the second sensor and the incident location on a ground surface underneath an object. It is noted that the hypotenuse of the second right triangle intersects with an outer underside edge of the object and the distance (H2) between the second sensor and the location on the ground surface directly below the first sensor is known.

The unobstructed height (h) underneath the object is then computed using the first distance and the second distance. To do so, this height may form a side of a first smaller right triangle formed within the first right triangle and may form a side of a second smaller right triangle formed within the second right triangle as seen in FIG. 6. According to the triangle proportionality theorem, a first relationship can be defined between the sides of the first smaller right triangle and the sides of the first right triangle as well as a second relationship can be defined between the sides of the second smaller right triangle and the sides of the second right triangle. These two relationships are as follows: x/d1=h/H1 and x+y/d2=h/H2. Unknown y can also be expressed in terms of known variables as follows: y=d2−d1−Δd, where Δd is the known distance between the first sensor and the second sensor. Based on these two relationships, one can solve for x and then h, thereby yielding

$$H = d 1 - d 2 - Δ d / ( d 1 / H 1 ) - ( d 2 / H 2 ) .$$

In this way, the unobstructed height underneath the object can be determined.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A robot control system for a monitored environment, comprising:
a central computer;
a plurality of sensors in data communication with the central computer, where each sensor is at a fixed location in the monitored environment and is configured to detect location of objects in the monitored environment; and
a plurality of robots residing in the monitored environment, each robot is comprised of a wireless communication receiver, a regulator, an actuator and a power source, such that the regulator receives motion commands directly from the central computer via the wireless communication receiver.

2. The robot control system of claim 1 wherein each robot is without sensors configured to navigate the robot.

3. The robot control system of claim 1 wherein the central computer is configured to receive location data for the plurality of robots from the plurality of sensors and determine a path for each robot in the plurality of robots.

4. The robot control system of claim 3 wherein the central computer runs a computer process for each robot in the plurality of robots, such that the computer process determines a trajectory for a given robot and issues the motion command to the given robot in accordance with the trajectory.

5. The robot control system of claim 4 wherein the central computer implements a traffic controller, where the traffic controller detects intersections amongst the paths determined for each robot in the plurality of robots and notifies computer processes for applicable robots of the intersections.

6. The robot control system of claim 1 wherein each sensor in the plurality of sensors is further defined as a camera.

7. The robot control system of claim 1 wherein the monitored environment is partitioned into two or more regions and the central computer implements a region handler for each of the two or more regions.

8. The robot control system of claim 1 wherein the central computer includes a human interface configured to receive a gesture from an operator and translate the gesture into a motion command for a given robot.

9. The robot control system of claim 1 wherein the central computer includes a microphone configured to receive a voice command from an operator and translate the voice command into a motion command for the given robot.

10. A computer-implemented method to control a plurality of robots in a monitored environment, comprising:
constructing a costmap for the monitored environment, where each cell in the cost map contains a numeric value indicating how undesirable it is to traverse in vicinity of that specific cell;
for each robot in the plurality of robots, sharing the costmap with the robot;
for each robot in the plurality of robots, determining a path for the robot to move in the monitored environment; and
for a given robot in the plurality of robots, updating numeric values in the costmap assigned to the given robot at periodic time intervals in accordance with paths determined for the remainder of robots in the plurality of robots.

11. The method of claim 10 wherein constructing the costmap includes assigning numeric values to each cell in the costmap for obstacles in the monitored environment.

12. The method of claim 11 further comprises constructing a costmap for the monitored environment at the period time intervals, where the obstacles in the monitored environment include stationary objects and moving objects.

13. The method of claim 11 further comprises receiving location data for the obstacles from a plurality of sensors, where each sensor is at a fixed location in the monitored environment and is configured to detect location of objects in the monitored environment.

14. The method of claim 10 wherein, for each robot in the plurality of robots, determining a path for the robot to move in the monitored environment includes sharing the path for the robot with the remainder of robots in the plurality of robots.

15. The method of claim 10 wherein updating numeric values in the costmap assigned to the given robot includes, for each of the remainder of robots in the plurality of robots, determining an individual robot cost for each cell in relation to the path of the given robot, such that the individual robot cost accounts for the path of the given robot and the path of the other robot.

16. The method of claim 15 wherein updating numeric values in the costmap assigned to the given robot further includes, for each cell in the costmap, summing the corresponding individual robot costs for each of the remainder of robots and adding sum of individual robot costs to numeric value of corresponding cell in the costmap.

17. The method of claim 10 further comprises controlling movement of the given robot in accordance with the updated costmap assigned to the given robot.

18. A computer-implemented method for determining an unobstructed height underneath an object in a monitored environment, comprising:
measuring, by a first sensor, a first distance from a location on the ground surface directly below the first sensor to an incident location on a ground surface underneath an object, where a hypotenuse of a right triangle intersects with an outer underside edge of the object and the right triangle is formed by the first sensor, the incident location and the location on the ground surface directly below the first sensor;
measuring, by a second sensor, a second distance from a location on the ground surface directly below the second sensor to a second incident location on a ground surface underneath the object, where a hypotenuse of a second right triangle intersects with the outer underside edge of the object and the second right triangle is formed by the second sensor, the second incident location and the location on the ground surface directly below the second sensor; and
computing, by a computer processor, an unobstructed height underneath the object using the first distance and the second distance, where height of the first sensor above the ground surface, the height of the second sensor above the ground surface, and a distance between the first sensor and the second sensor is known.
